(19) United States
(12) Patent Application Publication
(10) Pub. No.: US 2008/0106088 A1
(43) Pub. Date: May 8, 2008

(54) Retrofittable radio frequency identification connector

(75) Inventor: Bradley A. Rohlf, Lakeville, MN (US)

Correspondence Address: IPLM GROUP, P.A., POST OFFICE BOX 18455, MINNEAPOLIS, MN, 55418, US

(73) Assignee: D B Industries, Inc.

(21) Appl. No.: 11/759,377

(22) Filed: Jun. 7, 2007

Related U.S. Application Data
(60) Provisional application No. 60/856,607, filed on Nov. 3, 2006.

(51) Int. Cl. B42D 15/10

(52) U.S. Cl. 283/70; 283/55

(57) ABSTRACT

A radio frequency identification connector is configured and arranged to retrofittably connect a radio frequency identification device to a device such as a fall protection and fall arrest safety device.

This application claims the benefit of U.S. Provisional Application Ser. No. 60/856,607, filed Nov. 3, 2006.

### RELATED APPLICATIONS

This disclosure is related to the following co-pending applications (1) “Retrofittable Radio Frequency Identification Tag” by Brent J. Knoll et al., U.S. Provisional Application Ser. No. 60/811,965, filed Jun. 8, 2006; (2) “Radio Frequency Identification Tag” by Brent J. Knoll et al., U.S. patent application Ser. No. 29/249,952, filed Oct. 27, 2006; (3) “Retrofittable Radio Frequency Identification Connectors” by Brent J. Knoll et al., U.S. Provisional Application Ser. No. 60/856,607, filed Nov. 3, 2006; (4) “Radio Frequency Identification Connectors” by Bradley A. Rohlf, U.S. Provisional Application Ser. No. 60/856,771, filed Nov. 3, 2006; (5) “Connector for Radio Frequency Identification Device” by Bradley A. Rohlf, U.S. patent application Ser. No. 29/279,897, filed May 10, 2007; (6) “Retrofittable Radio Frequency Identification Connector” by Brent J, Knoll et al., Attorney Docket No. 221P182USU1, filed Jun. 7, 2007; (7) “Retrofittable Radio Frequency Identification Connector” by Bradley A. Rohlf, Attorney Docket No. 221P202USU1, filed Jun. 7, 2007; (8) “Retrofittable Radio Frequency Identification Connector” by Bradley A. Rohlf et al., Attorney Docket No. 221P200US01, filed Jun. 7, 2007; (9) “Radio Frequency Identification Connector” by Bradley A. Rohlf, Attorney Docket No. 221P187USU1, filed Jun. 7, 2007; and (10) “Radio Frequency Identification Connector” by Bradley A. Rohlf, Attorney Docket No. 221P203USU1, filed Jun. 7, 2007; which are not admitted as prior art with respect to the present disclosure by its mention in this section.

### FIELD OF THE INVENTION

The present invention relates to a retrofittable radio frequency identification connector for connecting radio frequency identification devices to devices such as fall protection and fall arrest safety devices.

### BACKGROUND OF THE INVENTION

To comply with industry standards, safety devices used for fall protection and fall arrest purposes should be inspected by the user prior to each use and by a competent person other than the user at least annually. To demonstrate compliance with the industry standards, the results of the inspections should be recorded in an inspection and maintenance log for each safety device identified by the model number, the serial number, and the date manufactured or purchased. The inspection and maintenance log should also include information such as the date inspected, the inspection items noted, corrective action, maintenance performed, and the initials of the person who approved the inspection. Other information may also be included such as the dates of the next inspection and maintenance.

For example, some safety devices commonly include labels on which the inspection and maintenance log information may be recorded. However, these labels may become difficult to write on or read should they become soiled. If a separate inspection and maintenance log is kept, it may be difficult to locate the separate log and keep it current, especially if the log is kept in a different location than the safety devices. Therefore, it is desired to provide an inspection and maintenance log that is easily accessible and convenient to use.

The present invention addresses the problems associated with the prior art devices and provides for radio frequency identification connectors for connecting radio frequency identification devices to devices such as fall protection and fall arrest safety devices for use with inspection and maintenance logs that are easily accessible and convenient to use.

### SUMMARY OF THE INVENTION

One aspect of the present invention provides an identification connector assembly configured and arranged for retrofittable connection to a device comprising an identification device and a housing including an aperture and opposing slots. The aperture is adapted to receive a fastener, and the opposing slots are adapted to receive a strap routed therethrough. The identification device is operatively connected to the housing.

Another aspect of the present invention provides an identification connector assembly configured and arranged for retrofittable connection to a device comprising an identification device, a housing including opposing slots, a strap including an intermediate portion interconnecting a first end and a second end, and a fastener. The identification device is operatively connected to the housing. The intermediate portion of the strap is routed through the opposing slots of the housing. The fastener includes a first portion operatively connected to the first end and a second portion operatively connected to the second end. The first and second portions mate to connect the first and second ends of the strap to connect the housing to the device.

Another aspect of the present invention provides an identification connector assembly configured and arranged for retrofittable connection to a device comprising an identification device, a fastener, a strap, and a housing. The strap includes an intermediate portion interconnecting a first end and a second end. The first end includes a first mating member and the second end includes a second mating member. The first and second mating members mate to connect the first and second ends of the strap. The housing includes an aperture and opposing slots. The fastener is inserted through the aperture, and the intermediate portion of the strap is routed through the opposing slots. The identification device is operatively connected to the housing.

### BRIEF DESCRIPTION OF THE DRAWINGS

FIG. 1 is a top view of a lanyard to which another embodiment retrofittable radio frequency identification connector is operatively connected constructed according to the principles of the present invention;

FIG. 2 is a top view of the retrofittable radio frequency identification connector shown in FIG. 1; and

FIG. 3 is a top view of the retrofittable radio frequency identification connector shown in FIG. 2 operatively connected to a strap.

### DETAILED DESCRIPTION OF A PREFERRED EMBODIMENT

A retrofittable radio frequency identification connectors constructed according to the principles of the present invention is designated by the numeral 300 in the drawings.

The radio frequency identification connector 300 is preferably for retrofittable connection to a completed, manufactured safety device as described herein, but it is recognized that the radio frequency identification connector 300 may also be retrofittably connected to other devices after manufacture of the devices has been completed. Examples of safety devices are safety harnesses, lanyards, self-retracting lifelines, and rescue equipment to which the radio frequency identification connector 300 may be retrofittably connected. The present invention is not limited to safety devices and may be used with any suitable devices. Further, although the connector 300 is preferably configured and arranged for retrofittable connection to a device, the connector 300 may be connected to a device during manufacture of the device.

Although the present invention is described herein as a connector, for use with a radio frequency identification device, it is recognized that the connector may also be used with other suitable identification devices such as, but not limited to, bar codes, serial numbers, and metallic codes. These identification devices may be used individually or in any combination with the connector of the present invention.

The radio frequency identification (hereinafter “RFID”) connector 300 includes a housing 301, which is preferably molded plastic such as urethane to accommodate an RFID device (not shown) contained therein. This is similar to how the identifying information is contained within the 134.2 kilohertz half-duplex electronic ID by Allflex USA, Inc. in Dallas Fort Worth, Tex. The housing 301 includes a flange 302 extending outward from a side of the housing 301 that includes an aperture 303. On each side of the flange 302 and on opposing sides from one another are flanges 304 and 306 with slots 305 and 307, respectively, extending outward from the housing 301. The housing 301, the flange 302 and the flanges 304 and 306 are preferably molded as an integral piece, but it is recognized that they may be separate components operatively connected.

The housing 301 is preferably configured and arranged to contain the RFID device and although the RFID device is shown and described as being contained within the housing 301, it is recognized that the RFID device may be otherwise operatively connected to the housing 301 by other suitable capturing, securing, or supporting means. For example, the RFID device could also be operatively connected to the housing by fasteners such as stitching, rivets, or cable ties.

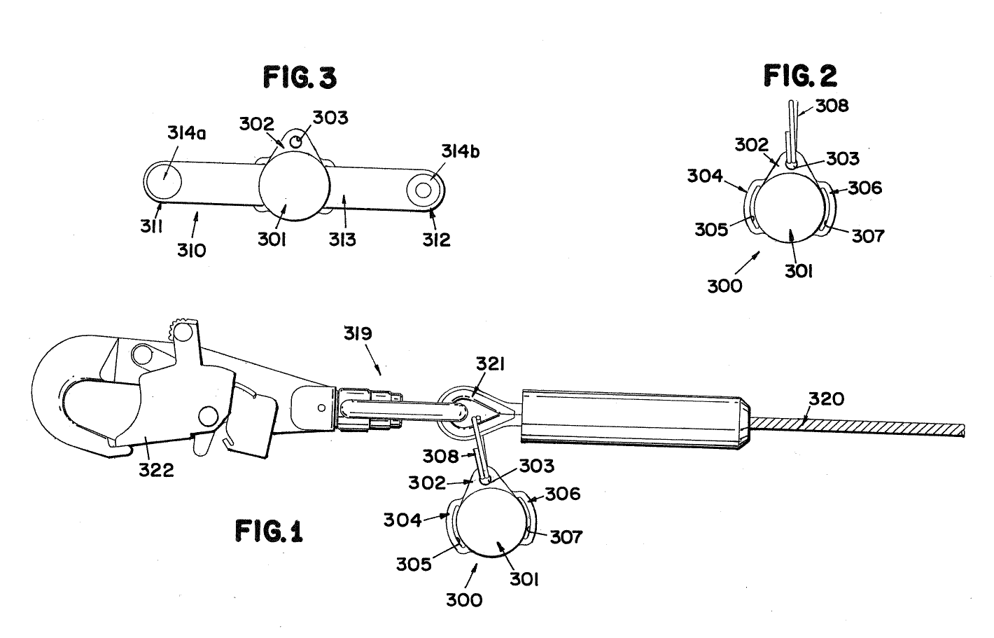

To attach the connector 300 to a safety device, an appropriate location is preferably selected on the safety device where the connector 300 will not interfere with movement of the worker or the worker's tools. Examples of safety devices to which the connector 300 may be connected include safety harnesses, lanyards, self-retracting lifelines, and rescue equipment. As shown in FIG. 1, an appropriate location on a self-retracting lifeline 319 is preferably the looped end 321 of the cable 320 to which the hook 322 is connected as is well known in the art. A fastener 308 such as a key ring is inserted through the aperture 303 in the flange 302 and also through the looped end 321 of the cable 320 thus securing the RFID device to the self-retracting lifeline 319. Although a key ring is shown in FIGS. 1 and 2, a cable tie or other suitable fastener may also be used. The connector 300 may be similarly secured to other types of safety devices.

Alternatively, as shown in FIG. 3, a strap 310 having a first end 311, a second end 312, and an intermediate portion 313 interconnecting the first end 311 and the second end 312 may be used to secure the RFID device to a safety device. The strap 310 may be made of polyester webbing, vinyl, or any other suitable material. The first end 311 includes a first mating fastener, portion 314a and the second end 312 includes a second mating fastener portion 314b. One of the ends 311 and 312 of the strap 310 is inserted through the slots 305 and 307 so that one of the ends 311 and 312 extends outward from proximate the flange 304 and the other of the ends 311 and 312 extends outward from proximate the flange 306. The strap 310 may then be positioned about a portion of a safety device and the ends 311 and 312 secured to one another by securing the mating fastener portions 314a and 314b to one another thus securing the RFID device to the safety device.

Preferably, the mating fastener portions 314a and 314b are permanently secured together. An example of a suitable permanent fastener is a ratchet rivet such as a two piece ratchet rivet, Part No. 236-170406-00, by ITW Fastex in Des Plaines, Ill. It is recognized that rivets and other types of permanent fasteners may be used. A permanent fastener is a fastener than cannot be released once connected. It is also recognized that the fastener may also be a releasable fastener so that the RFID connector 300 may be easily re-used if desired. For an easily re-usable connector, any suitable releasable fastener may be used such as a snaps, hook and loop, and buckles. If a permanent fastener is used and it is desired to re-use the connector 300, the permanent fastener can be removed and the connector 300 can be attached by other suitable fasteners.

The strap 310 may be used in addition to the fastener 308 to prevent the housing 301 from catching on something while the user is performing tasks or otherwise interfering with the performance of the user's tasks. Thus, possible connection options for connecting the housing 301 to a device include inserting a fastener through the aperture 303 and connecting the fastener to the device, routing a strap through the slots 305 and 307 and connecting the strap to the device, and using both a fastener and a strap. Therefore, either the aperture 303 or the slots 305 and 307 could be eliminated from the connector 300.

Once the connector 300 is connected to the safety device, the connector 300 can be located and the identifying information of the connector 300 can be scanned. The identifying information of the connector 300 is linked to data stored in a computer database where the inspection and maintenance log information can be entered and saved for the safety device. Examples of how this can be accomplished are disclosed in the following co-pending applications, the entire contents of which are hereby incorporated by reference in their entirety: (1) “Method of Facilitating Controlled Flow of Information for Safety Equipment Items and Database Related Thereto” by Dean R. Kaartinen et al., U.S. patent application Ser. No. 11/759,148, filed Jun. 6, 2007; (2) “Direct Data Input For Database For Safety Equipment Items and Method” by Dean R. Kaartinen et al., U.S. patent application Ser. No. 11/759,152, filed Jun. 6, 2007; (3) “Method of Retrofitting Safety Equipment Items and Database” by Dean R. Kaartinen et al., U.S. patent application Ser. No. 11/759,158, filed Jun. 6, 2007; and (4) “Centralized Database of Information Related to Inspection of Safety Equipment Items Inspection and Method” by Dean R. Kaartinen et al., U.S. patent application Ser. No. 11/759,175, filed Jun. 6, 2007. The scanning of the identifying information of the connector 300 makes recordation of the inspection and maintenance log information in the computer database easy because the connector 300 is easily accessible and convenient to use regardless if the safety device is soiled.

The above specification, examples and data provide a complete description of the manufacture and use of the composition of the invention. Since many embodiments of the invention can be made without departing from the spirit and scope of the invention, the invention resides in the claims hereinafter appended.

We claim:

1. An identification connector assembly configured and arranged for retrofittable connection to a device, comprising:
a) an identification device; and
b) a housing including an aperture and opposing slots, the aperture adapted to receive a fastener, the opposing slots adapted to receive a strap routed therethrough, the identification device being operatively connected to the housing.

2. The assembly of claim 1, wherein the identification device is a radio frequency identification device.

3. The assembly of claim 1, wherein the housing is molded plastic and the identification device is molded into the housing.

4. The assembly of claim 1, wherein the aperture is proximate a top portion of the housing and the opposing slots are proximate opposing side portions of the housing.

5. An identification connector assembly configured and arranged for retrofittable connection to a device, comprising:
a) an identification device;
b) a housing including opposing slots, the identification device being operatively connected to the housing,
c) a strap including an intermediate portion interconnecting a first end and a second end, the intermediate portion being routed through the opposing slots of the housing; and
d) a fastener including a first portion operatively connected to the first end and a second portion operatively connected to the second end, the first and second portions mating to connect the first and second ends of the strap to connect the housing to the device.

6. The assembly of claim 5, wherein the identification device is a radio frequency identification device.

7. The assembly of claim 5, wherein the housing is molded plastic and the identification device is molded into the housing.

8. The assembly of claim 5 wherein the fastener is a permanent fastener.

9. The assembly of claim 5, wherein the fastener is a fastener selected from the group consisting of a rivet, a ratchet rivet, a snap, hook and loop, and a buckle.

10. The assembly of claim 5, further comprising an aperture in the housing adapted to receive a second fastener to connect the housing to the device.

11. An identification connector assembly configured and arranged for retrofittable connection to a device, comprising.
a) an identification device;
b) a fastener;
c) a strap including an intermediate portion interconnecting a first end and a second end, the first end including a first mating member and the second end including a second mating member, the first and second mating members mating to connect the first and second ends of the strap; and
d) a housing including an aperture and opposing slots, the fastener being inserted through the aperture, the intermediate portion of the strap being routed through the opposing slots, the identification device being operatively connected to the housing.

12. The assembly of claim 11, wherein the identification device is a radio frequency identification device.

13. The assembly of claim 11, wherein the housing is molded plastic and the identification device is molded into the housing.

14. The assembly of claim 11, wherein the fastener is a fastener selected from the group consisting of a key ring and a cable tie.

15. The assembly of claim 11, wherein the first and second mating members are a mating fastener selected from the group consisting of a ratchet rivet, a snap, hook and loop, and a buckle.
